(19) United States
(12) Patent Application Publication
(10) Pub. No.: US 2026/0305780 A1
(43) Pub. Date: Oct. 8, 2026

(54) ATHLETIC EQUIPMENT BAG INCLUDING AN EXHAUST SYSTEM

(71) Applicant: NIKE, Inc., Beaverton, OR (US)

(72) Inventor: Harrison B. PUGESEK, Portland, OR (US)

(73) Assignee: NIKE, Inc., Beaverton, OR (US)

(21) Appl. No.: 19/098,253

(22) Filed: Apr. 2, 2025

(51) Int. Cl. A45C 3/00; A45C 13/10; A45C 15/00; F26B 9/00

(52) U.S. Cl. CPC A45C 3/001; A45C 13/103; A45C 15/00; F26B 9/003; A45C 2003/002; A45C 2003/007

(57) ABSTRACT

A bag with a top end and a bottom end opposite the top end; a main body extending from the top end toward the bottom end, the main body including a main storage compartment: a first wall disposed on a first side of the main body; a panel disposed adjacent the bottom end of the bag; one or more openings disposed in the panel; and at least one flow device attached to the first wall.

### FIELD

The present invention relates in general to athletic equipment bags, and more particularly, to bags including an exhaust system.

### BACKGROUND

This section provides background information related to the present disclosure which is not necessarily prior art.

Athletic equipment bags are becoming increasingly popular among athletes in numerous sports because of their portability, functionality in storing various items, and aesthetic designs. Known athletic equipment bags are lightweight and flexible to provide easier transport of the athlete's equipment, clothing, and other gear. Athletic equipment bags typically include multiple compartments enclosed entirely within an interior the bag. These bags are generally closed to prevent various items within the interior of the bag from falling out. However, in the event that wet items or clothing are stored in the bag, the closed environment leads to undesirable odors and moisture within the bag.

### BRIEF DESCRIPTION OF THE DRAWINGS

The detailed description of the invention will be described in relation to the accompanying drawings. In the drawings, the following figures have the following general nature:

FIG. 1 is a front schematic view of an athletic equipment bag;

FIG. 2 is a top schematic view of the athletic equipment bag of FIG. 1;

FIG. 3 is a perspective view of an alternative athletic equipment bag; and

FIG. 4 is a detail view of the athletic equipment bag of FIG. 3.

Corresponding reference numerals indicate corresponding parts throughout the several views of the drawings.

### DETAILED DESCRIPTION

The present disclosure overcomes these challenges and other known disadvantages with existing athletic equipment bags by providing a bag with an exhaust system that allows for users to ventilate their athletic bag.

Example configurations will now be described more fully with reference to the accompanying drawings. Example configurations are provided so that this disclosure will be thorough and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc., may be used herein to describe various elements, components, regions, layers and/or sections. These elements, components, regions, layers and/or sections should not be limited by these terms. These terms may be only used to distinguish one element, component, region, layer or section from another region, layer, or section. Terms such as “first,” “second,” and other numerical terms do not imply a sequence or order unless clearly indicated by the context. Thus, a first element, component, region, layer, or section discussed below could be termed a second element, component, region, layer, or section without departing from the teachings of the example configurations. In the discussion that follows, terms “about,” “approximately,” “substantially,” and the like, when used in describing a numerical value, denote a variation of +/- 10% of that value, unless specified otherwise.

When an element or layer includes a directional and/or spatial term (e.g., top, bottom, medial, lateral, etc.), the directional and/or spatial term may be used relative to when the athletic equipment bag is upright on a flat, level surface.

The subject matter of embodiments of the present disclosure is described with specificity herein to meet statutory requirements. But the description itself is not intended to necessarily limit the scope of claims. Rather, the claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly stated.

Although the description is in reference to an athletic equipment bag, it should be appreciated that such reference is merely exemplary and that the present disclosure is not limited to bags intended for use in storing athletic equipment. Bags include different types of portable storage apparatuses, such as, but not limited to, purses, backpacks, satchels, carriers, and the like. The technology disclosed herein may equally be used to create various types of bags. To alleviate confusion and to provide a more readable disclosure, embodiments simply reference bags. To that end and to provide a robust disclosure, different components or portions of bags are discussed herein, including zippers, panels, and compartments.

Aspects hereof provide a bag that includes a main storage compartment that is accessible by opening one or more panels. One or more of the panels are releasably fastened to adjacent panels by way of a closure system, such as a zipper or other releasable fastener (e.g., hook-and-loop strips, snaps, buttons, hooks, and the like). The bag may also include one or more accessory storage compartments constructed into the one or more panels, into a back panel of the bag, or inside a main storage compartment of the bag.

The main storage compartment generally includes a storage space that may be larger than the accessory storage compartments and might include one or more additional storage pockets accessible from inside or outside the storage space. The accessory storage compartments are generally separated from the storage space of the main storage compartment and might be used to stow various items, such as athletic balls, footwear, towels, uniforms, sports drinks, sports supplements, and the like. The terms “storage” and “stowage” might be used interchangeably in this description, as well as the terms “storage area,” “compartment,” and “storage space.” In addition, “accessory storage compartments” may also be referred to herein as “accessory compartments,” “accessory pockets,” “storage pockets,” or just “pockets.”

In a further aspect, the bag may be wearable as a backpack. For instance, the bag might include one or more straps that can be worn on one or both shoulders of a user. A normal manner of wear for the bag, when configured as a duffel bag, is for the user to place one or both arms through the one or more straps such that a panel of the backpack contacts the user’s back. In one aspect, the backpack is configured such that items stored in the main storage compartment are accessible by opening the closure system securing any one or more of the panels. Items stored within the accessory storage compartments are also accessible by opening any one or more of the fasteners or panels.

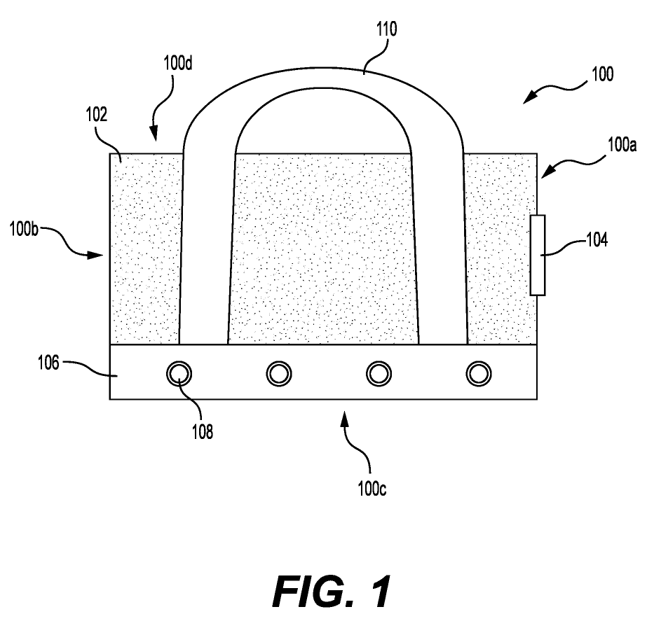

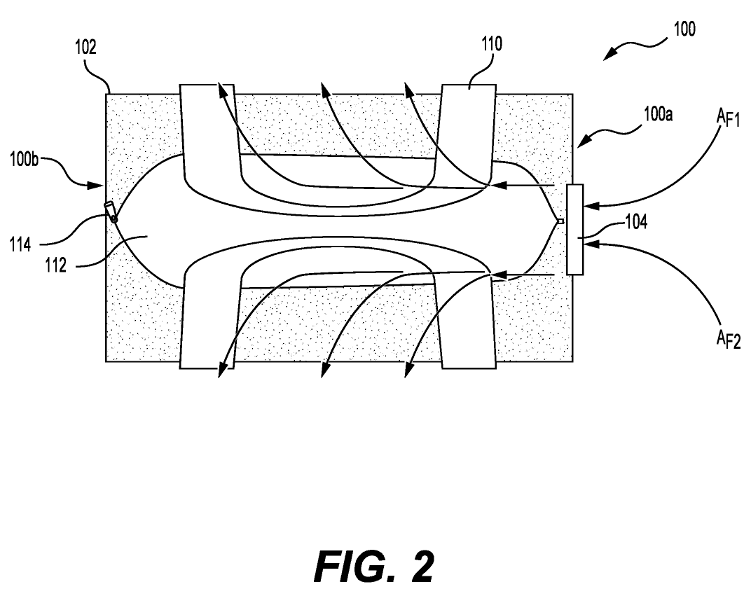

FIG. 1 depicts a schematic view of a bag 100. The bag 100 may include a first (right) wall 100a, a second (left) wall 100b that is positioned opposite of the first wall 100a, a bottom end 100c, and a top end 100d that is positioned opposite of the bottom end 100c. The bag 100 includes a main body 102 and a flow device 104. The main body 102 at least partially encloses a main storage compartment 112 (shown in FIG. 2). The first wall 100a and the second wall 100b may form a portion of the main body 102. For example, the first wall 100a may be disposed on a first side of the main body 102, and the second wall 100b may be disposed on a second side of the main body 102 opposite the first side of the main body 102. The main body 102 includes a closure system 114 (shown in FIG. 2) that is operable between a first (open) configuration and a second (closed) configuration to reveal and provide access to the main storage compartment 112 when positioned in the open configuration. In some examples, the flow device 104 may include a fan, an impeller, an air circulator, a ventilator, a vacuum, a blower, or the like. The bag 100 includes a panel 106, one or more openings 108, and one or more straps 110.

The flow device 104 is attached to or otherwise coupled with the first wall 100a. In an example, the flow device 104 is stitched to the first wall 100a. The flow device 104 is positioned along the first wall 100a such that the flow device 104 may pull air into or out of the main storage compartment 112 and direct the air toward a ground adjacent portion of the main storage compartment 112. For example, the flow device 104 may be positioned on the first wall 100a adjacent the top end 100d. In other examples, the flow device 104 may be positioned along the first wall 100a as desired to direct airflow into the main storage compartment 112 and out of the one or more openings 108.

The panel 106 is positioned adjacent the bottom end 100c of the bag 100. The panel 106 may be integrally formed with or connected to the main body 102. The one or more openings 108 are disposed adjacent the bottom end 100c of the bag 100 and are formed in the panel 106. In an example, the panel 106 may be a mesh, lining, or a fabric. The one or more openings 108 may be formed as a circular hole through the panel 106. In an example, the one or more openings 108 may be circular, triangular, square, or any other desired shape to aid in airflow. In some examples, the one or more openings 108 may include a grommet or any other suitable strip or ring. In some examples, the one or more openings 108 may include one or more valves. In other examples, the bag 100 may only include either one of the panel 106 or the one or more openings 108. When the bag 100 includes only the panel 106, the panel 106 is formed as a permeable or semi-permeable mesh. As will be described in greater detail below, the flow device 104 circulates fluid (e.g., air) through the flow device 104 and into the bag 100 and out through the one or more openings 108. For example, a user of the bag 100 may store wet or odorous clothing items in the bag 100, and the flow device 104 may circulate the air within the main storage compartment 112 in order to ventilate the bag 100, reduce the smell of the clothing items, and aid in drying the clothing items.

Referring to FIG. 2, a top schematic view of the bag 100 is shown with the closure system 114 shown in the open position for illustrative purposes. In an example, air is pulled from the external environment into the main storage compartment 112 via the flow device 104. In an example, as the air is pulled from the external environment toward the top end 100d, the air is directed as a first air flow A_{F1} and a second air flow A_{F2}. The air flows A_{F1} and A_{F2} are directed to internal portions of the main storage compartment 112. As the air flows A_{F1} and A_{F2} circulate through the main storage compartment 112, the air flows A_{F1} and A_{F2} are directed toward the bottom end 100c of the bag 100. Two air flows A_{F1} and A_{F2} are shown for illustrative purposes to depict the air traveling through the storage compartment 112. The air flow coming from the flow device 104 may be a singular air flow traveling through the main storage compartment 112. In some examples, there may be more than one flow device 104 to produce multiple air flows. In other examples, the flow device 104 may include one or more dividers to produce split air flow. The dryer air of the external environment pushes the humid air in the main storage compartment 112 toward the bottom end 100c and out of the one or more openings 108, as the one or more openings 108 are the singular point of fluid exit of the main storage compartment 112. In some examples, the flow device 104 may be configured to pull air from the main storage compartment 112 to the external environment. In such examples, the fluid may flow through the one or more openings 108, into the main storage compartment 112, and through the flow device 104.

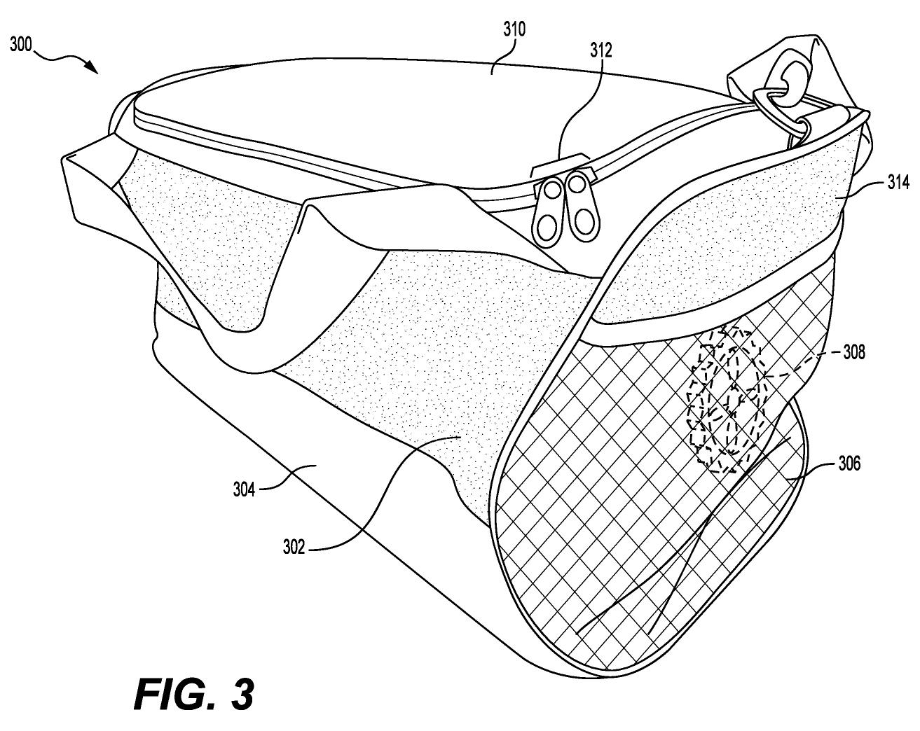

Referring to FIG. 3, a bag 300 is shown. The bag 300 includes a body 302, a panel 304, a pocket 306, a fan 308, a flap 310, a closure mechanism 312, and at least one side panel 314. In an example, the at least one side panel 314 is coupled to or integrally formed with a first side of the body 302. In an example, the pocket 306 is coupled with or attached to the at least one side panel 314. In some examples, the pocket 306 may be disposed along the body 302 or any other panel of the bag 300. The pocket 306 may be mesh or otherwise formed of a permeable material to permit air flow in our out. The pocket 306 may be formed of a semi-permeable material. The fan 308 is disposed in the at least one side panel 314. The fan 308 may be stitched, glued, sewn, or otherwise attached to the at least one side panel 314. A portion of the fan 308 extends outwardly from the at least one side panel 314 such that the extending portion of the fan 308 is disposed between the pocket 306 and the at least one side panel 314. In an example, the pocket 306 may operate as a filter for the fan 308. For example, the pocket 306 may serve as a membrane for blocking larger particles entering the fan 308.

The fan 308 is operable between at least a first configuration and a second configuration. In the first configuration, the fan 308 is off and in an unpowered state. In the second configuration, the fan 308 is on and in a powered state in which the fan 308 draws ambient air from outside of the bag 300 into interior portions of the bag 300, as previously described with respect to FIG. 2. In some example, the fan 308 is operable in a third configuration in which the fan is on and in a powered state in which the fan 308 draws air from interior portions of the bag 300 to the ambient environment. Although not shown, the bag 300 may include one or more openings disposed in the panel 304 configured to direct air out of the bag 300 as previously described with respect to bag 100.

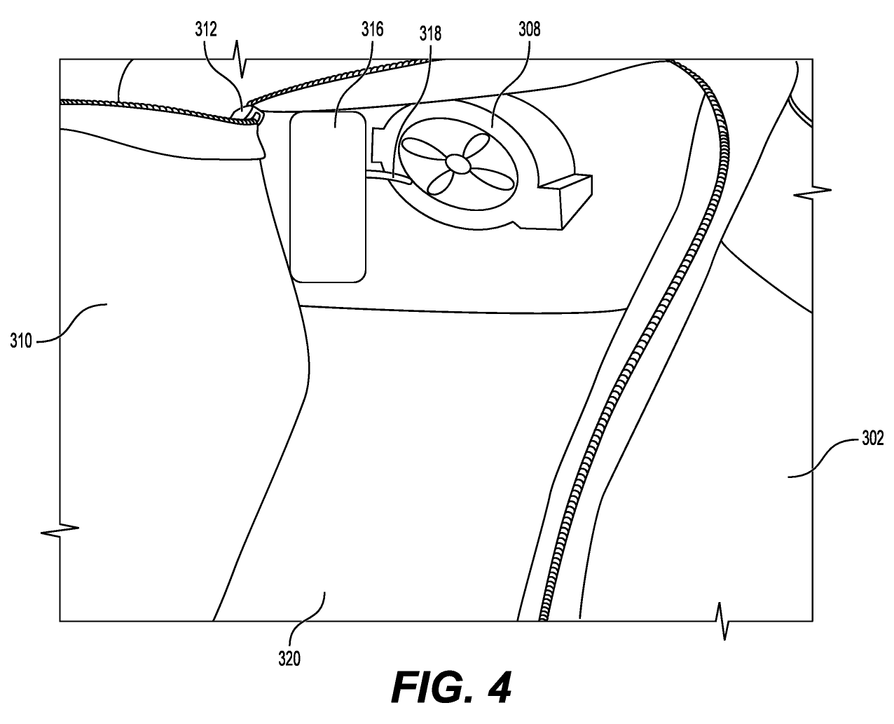

Referring to FIG. 4, the bag 300 may include one or more power supply devices 316 communicably coupled to the fan 308 via a wire 318. In an example, the one or more power supply devices 316 is a battery. The closure mechanism 312 of the bag 300 is operable between a first (open) configuration and a second (closed) configuration to reveal a main storage compartment 320 when positioned in the open configuration. In some examples, portions of the fan 308 and the one or more power supply devices 316 are disposed within the main storage compartment 320.

Since many possible embodiments may be made of the invention without departing from the scope thereof, it is to be understood that all matter herein set forth or shown in the accompanying drawings is to be interpreted as illustrative and not in a limiting sense.

The following clauses provide an exemplary configuration for an article of footwear and sole structure described above.

Clause 1. A bag comprising: a top end and a bottom end opposite the top end; a main body extending from the top end toward the bottom end, the main body including a main storage compartment: a first wall disposed on a first side of the main body; a panel disposed adjacent the bottom end of the bag; one or more openings disposed in the panel; and at least one flow device attached to the first wall.

Clause 2. The bag of Clause 1, wherein the flow device includes a fan.

Clause 3. The bag of Clause 1, wherein the flow device is positioned on the panel adjacent to the top end of the bag.

Clause 4. The bag of Clause 1, wherein the one or more openings include grommets.

Clause 5. The bag of Clause 1, wherein the panel is comprised of a fabric material.

Clause 6. The bag of Clause 1, wherein the flow device is connected to the first wall.

Clause 7. The bag of Clause 1, wherein the flow device is configured to draw a fluid from the external environment into the main storage compartment.

Clause 8. The bag of Clause 1, wherein the flow device is configured to draw a fluid from the main storage compartment to the external environment.

Clause 9. The bag of Clause 1, wherein the panel is comprised of a semi-permeable material.

Clause 10. A bag comprising: a body including a main storage compartment: at least one side panel disposed on a first side of the body; a pocket attached to the at least one side panel; and a fan attached to the at least one side panel, wherein a portion of the fan is disposed between the pocket and the at least one side panel.

Clause 11. The bag of Clause 10, wherein the pocket is formed of a mesh material.

Clause 12. The bag of Clause 10, wherein a portion of the fan is disposed in the main storage compartment.

Clause 13. The bag of Clause 10, wherein the bag includes one or more openings.

Clause 14. The bag of Clause 10, wherein the bag further includes a power supply communicably coupled to the fan.

Clause 15. The bag of Clause 14, wherein the power supply is disposed within the main storage compartment.

Clause 16. The bag of Clause 10, wherein the bag includes a closure system configured to provide access to the main storage compartment.

We claim:

1. A bag comprising:
a top end and a bottom end opposite the top end;
a main body extending from the top end toward the bottom end, the main body including a main storage compartment:
a first wall disposed on a first side of the main body;
a panel disposed adjacent the bottom end of the bag;
one or more openings disposed in the panel; and
at least one flow device attached to the first wall.

2. The bag of claim 1, wherein the flow device includes a fan.

3. The bag of claim 1, wherein the flow device is positioned on the panel adjacent to the top end of the bag.

4. The bag of claim 1, wherein the one or more openings include grommets.

5. The bag of claim 1, wherein the panel is comprised of a fabric material.

6. The bag of claim 1, wherein the flow device is connected to the first wall.

7. The bag of claim 1, wherein the flow device is configured to draw a fluid from the external environment into the main storage compartment.

8. The bag of claim 1, wherein the flow device is configured to draw a fluid from the main storage compartment to the external environment.

9. The bag of claim 1, wherein the panel is comprised of a semi-permeable material.

10. A bag comprising:
a body including a main storage compartment:
at least one side panel disposed on a first side of the body;
a pocket attached to the at least one side panel; and
a fan attached to the at least one side panel, wherein a portion of the fan is disposed between the pocket and the at least one side panel.

11. The bag of claim 10, wherein the pocket is formed of a mesh material.

12. The bag of claim 10, wherein a portion of the fan is disposed in the main storage compartment.

13. The bag of claim 10, wherein the bag includes one or more openings.

14. The bag of claim 10, wherein the bag further includes a power supply communicably coupled to the fan.

15. The bag of claim 14, wherein the power supply is disposed within the main storage compartment.

16. The bag of claim 10, wherein the bag includes a closure system configured to provide access to the main storage compartment.
